(19) United States
(12) Patent Application Publication
(10) Pub. No.: US 2010/0321682 A1
(43) Pub. Date: Dec. 23, 2010

(54) HOLDING FIXTURE, PLACEMENT METHOD OF HOLDING FIXTURE, AND MEASUREMENT METHOD

(75) Inventors: Eiji KATO, Miyagi (JP); Shigeki NISHINA, Miyagi (JP); Kodo KAWASE, Aichi (JP)

Correspondence Address: GREENBLUM & BERNSTEIN, P.L.C., 1950 ROLAND CLARKE PLACE, RESTON, VA, 20191, US

(73) Assignee: ADVANTEST CORPORATION, Tokyo (JP)

(21) Appl. No.: 12/776,538

(22) Filed: May 10, 2010

(30) Foreign Application Priority Data
May 15, 2009 (JP) 2009-119092

(51) Int. Cl. G01N 21/01

(52) U.S. Cl. 356/244

(57) ABSTRACT

A container according to the present invention contains at least a part of a device under test to be measured by a terahertz wave measurement device. The container includes a gap portion that internally disposes at least a part of the device under test, and an enclosure portion that includes a first flat surface portion and a second flat surface portion, and disposes the gap portion between the first flat surface portion and the second flat surface portion, thereby enclosing the gap portion. Moreover, a relationship n1−0.1≦n2≦n1+0.1 holds where n2 denotes a refractive index of the enclosure portion, and n1 denotes a refractive index of the device under test. Further, the first flat surface portion intersects at the right angle with a travel direction of the terahertz wave.

### BACKGROUND ART

1. Field of the Invention

The present invention relates to tomography using an electromagnetic wave (the frequency thereof is equal to or more than 0.01 [THz], and equal to or less than 100 [THz]) (such as a terahertz wave (the frequency thereof is equal to or more than 0.03 [THz], and equal to or less than 10 [THz]), for example).

2. Description of the Prior Art

There has conventionally been the computed tomography (CT) as a method for obtaining tomographic information on a device under test. This method conducted while a generator and a detector of the X ray are used is referred to as X-ray CT. With the X-ray CT, it is possible to acquire tomographic information on a human body in non-destructive and non-contact manner.

However, it is difficult for the X-ray CT to detect internal states (such as defects and distortions) of industrial products constructed by semiconductors, plastics, ceramics, woods, and papers (referred to as “raw materials” hereinafter). This is because the X-ray presents a high transmission property to any materials.

On the other hand, the terahertz wave properly transmits through the raw materials of the industrial products described above. Therefore, the CT carried out while a generator and a detector of the terahertz wave are used (referred to as “terahertz CT” hereinafter) can detect internal states of the industrial products. Patent Document 1 and Non-Patent Document 1 describe the terahertz CT.
(Patent Document 1) U.S. Pat. No. 7,119,339
(Non-Patent Document 1) S. Wang et al., “Pulsed terahertz tomography,” J. Phys. D, Vol. 37 (2004), R1-R36

### SUMMARY OF THE INVENTION

However, according to the terahertz CT, when the terahertz wave is obliquely made incident to or emitted from a device under test, the terahertz wave is refracted, and thus does not travel straight. On this occasion, it is assumed that the refractive index of the ambient air of the device under test is 1, and the refractive index of the device under test for the terahertz CT is more than 1.

FIG. 13 shows estimated optical paths of the terahertz wave when the refractive index of a conventional device under test is 1.4, and the refractive index of the ambient air of the device under test is 1. Referring to FIG. 13, it is appreciated that terahertz wave made incident from the left of the device under test (DUT) are refracted by the DUT.

Due to the fact that the terahertz wave does not travel straight, the terahertz wave cannot reach a detector, and an image of the DUT cannot thus be obtained at a sufficient sensitivity.

Moreover, due to the fact that the terahertz wave does not travel straight, a detected terahertz wave may not have traveled straight through the DUT before the arrival. Therefore, when an image of the DUT is obtained from the detected terahertz wave, artifacts such as obstructive shadows and pseudo images may appear on the image.

Therefore, it is an object of the present invention, when an electromagnetic wave (the frequency thereof is equal to or more than 0.01 [THz] and equal to or less than 100 [THz]) including the terahertz wave is fed to a DUT for measurement, to restrain refraction of the electromagnetic wave including the terahertz wave by the DUT.

According to the present invention, a container that contains at least a part of a device under test to be measured by an electromagnetic wave measurement device, includes: a gap portion that internally disposes at least a part of the device under test; and an enclosure portion that includes a first flat surface portion and a second flat surface portion, and disposes the gap portion between the first flat surface portion and the second flat surface portion, thereby enclosing the gap portion, wherein: a relationship n1−0.1≦n2≦n1+0.1 holds, where n2 denotes a refractive index of the enclosure portion and n1 denotes a refractive index of the device under test; and the electromagnetic wave measurement device outputs an electromagnetic wave having a frequency equal to or more than 0.01 [THz] and equal to or less than 100 [THz] toward the device under test.

According to the thus constructed container that contains at least a part of a device under test to be measured by an electromagnetic wave measurement device, a gap portion internally disposes at least a part of the device under test. An enclosure portion includes a first flat surface portion and a second flat surface portion, and disposes the gap portion between the first flat surface portion and the second flat surface portion, thereby enclosing the gap portion. A relationship n1−0.1≦n2≦n1+0.1 holds, where n2 denotes a refractive index of the enclosure portion and n1 denotes a refractive index of the device under test. The electromagnetic wave measurement device outputs an electromagnetic wave having a frequency equal to or more than 0.01 [THz] and equal to or less than 100 [THz] toward the device under test.

According to the container of the present invention, a contour of a plane shape of the gap portion may include an arc.

According to the container of the present invention, a radius of the contour of the plane shape of the gap portion may change according to the height of the gap portion.

According to the container of the present invention, the enclosure portion can be divided along a separation surface; and the separation surface may intersect with the gap portion.

The container according to the present invention may include an insertion member that is inserted in a space between the device under test and the gap portion, wherein: a contour of a plane shape of an integrated body of the device under test and the insertion member is concentric with a contour of a plane shape of the gap portion; and a relationship n1−0.1≦n3≦n1+0.1 holds, where n3 denotes a refractive index of the insertion member and n1 denotes the refractive index of the device under test.

According to the container of the present invention, a distance between the contour of the plane shape of the integrated body of the device under test and the insertion member and the contour of the plane shape of the gap portion may be equal to or less than a quarter of the wavelength of the electromagnetic wave output from the electromagnetic wave measurement device toward the device under test.

The container of the present invention may include a filling member that is filled in a space between the device under test and the gap portion, wherein a relationship n1−0.1≦n4≦n1+0.1 holds, where n4 denotes a refractive index of the filling member and n1 denotes the refractive index of the device under test.

According to the container of the present invention, a distance between a contour of a plane shape of the device under test and a contour of a plane shape of the gap portion may be equal to or less than a quarter of the wavelength of the electromagnetic wave output from the electromagnetic wave measurement device toward the device under test.

According to the present invention, a container arrangement method for arranging the container according to the present invention containing the device under test for measuring the device under test by the electromagnetic wave measurement device, includes a step of arranging the container such that the first flat surface portion intersects, at the right angle, with a travel direction of the electromagnetic wave output from the electromagnetic wave measurement device toward the device under test.

According to the present invention, a container arrangement method for arranging the container according to the present invention containing the device under test for measuring the device under test by the electromagnetic wave measurement device, includes a step of arranging the container such that the first flat surface portion intersects with a travel direction of the electromagnetic wave output from the electromagnetic wave measurement device toward the device under test at an angle more than 0 degree and less than 90 degrees.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the container and the device under test move horizontally with respect to an optical path of the electromagnetic wave while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein an optical path of the electromagnetic wave moves horizontally with respect to the container while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the device under test rotates about a line extending vertically as an axis of rotation while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the container and an optical path of the electromagnetic wave rotate about a line extending vertically as an axis of rotation while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the container and an optical path of the electromagnetic wave move vertically with respect to the device under test while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the container and the device under test move vertically with respect to an optical path of the electromagnetic wave while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein the device under test moves vertically with respect to the container and an optical path of the electromagnetic wave while the output step and the detection step are carried out.

According to the present invention, a measurement method of the device under test contained in the container according to the present invention using the electromagnetic wave measurement device, includes: an output step of outputting the electromagnetic wave by the electromagnetic wave measurement device; and a detection step of detecting the electromagnetic wave which has transmitted through the device under test by the electromagnetic wave measurement device, wherein an optical path of the electromagnetic wave moves vertically with respect to the container and the device under test while the output step and the detection step are carried out.

### BRIEF DESCRIPTION OF THE DRAWINGS

FIG. 1 is a plan view of a container 10 according to a first embodiment of the present invention;

FIG. 2 is a plan view of a state in which at least a part of a device under test (DUT) 1 is stored in the container 10 according to the first embodiment of the present invention, and a terahertz wave is irradiated on the container 10;

FIG. 3 is an enlarged plan view of the DUT 1 and the gap portion 11 when at least a part of the DUT 1 is stored in the container 10;

FIGS. 4(a) and 4(b) are plan views of the container 10 and the terahertz wave measurement device for describing the operation of the second embodiment;

FIGS. 5(a) and 5(b) are plan views of the container 10 and the terahertz wave measurement device for describing the operation of the third embodiment;

FIGS. 6(a) and 6(b) are plan views of the container 10 and the terahertz wave measurement device for describing the operation of the fourth embodiment;

FIGS. 7(a) and 7(b) are front views of the container 10 and the terahertz wave measurement device according to the fifth embodiment;

FIGS. 8(a) and 8(b) are front views of the container 10 and the terahertz wave measurement device according to the sixth embodiment

FIG. 9 is a plan view of a state in which at least a part of the DUT 1 is stored in the container 10 according to the seventh embodiment, and the terahertz wave is irradiated on the container 10;

FIG. 10 is a plan view of a state in which at least a part of the DUT 1 is stored in the container 10 according to the eighth embodiment, and the terahertz wave is irradiated on the container 10;

FIG. 11 is a plan view of a state in which at least a part of the DUT 1 is stored in the container 10 according to the ninth embodiment, and the terahertz wave is irradiated on the container 10;

FIGS. 12(a) and 12(b) are views when the DUT 1 is stored in the container 10 according to the tenth embodiment, in which FIG. 12(a) is a cross sectional view, and FIG. 12(b) is a plan view; and

FIG. 13 shows estimated optical paths of the terahertz wave when the refractive index of a conventional device under test is 1.4, and the refractive index of the ambient air of the device under test is 1.

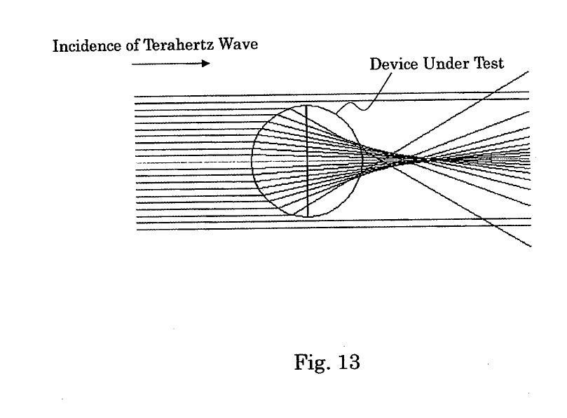

### BEST MODE FOR CARRYING OUT THE INVENTION

A description will now be given of embodiments of the present invention referring to drawings.

### First Embodiment

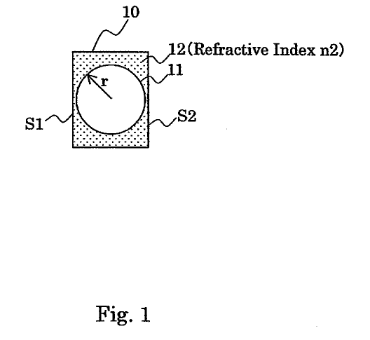

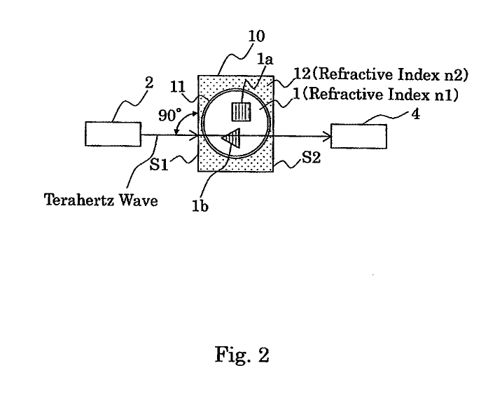

FIG. 1 is a plan view of a container 10 according to a first embodiment of the present invention. FIG. 2 is a plan view of a state in which at least a part of a device under test (DUT) 1 is stored in the container 10 according to the first embodiment of the present invention, and a terahertz wave is irradiated on the container 10.

Referring to FIG. 2, a terahertz wave measurement device (electromagnetic wave measurement device) includes a terahertz wave output device 2 and a terahertz wave detector 4. The terahertz wave output device 2 outputs the terahertz wave. The terahertz wave detector 4 detects the terahertz wave which has transmitted through the DUT 1 and the container 10.

It should be noted that the terahertz wave measurement device (electromagnetic wave measurement device) employs, as an electromagnetic wave to be output and to be detected, the terahertz wave (the frequency thereof is equal to or more than 0.03 [THz] and equal to or less than 10 [THz], for example) as described above. However, the electromagnetic waves to be output and detected by the terahertz wave measurement device (electromagnetic wave measurement device) are not limited to the terahertz waves, and may be electromagnetic waves the frequency of which is equal to or more than 0.01 [THz] and equal to or less than 100 [THz].

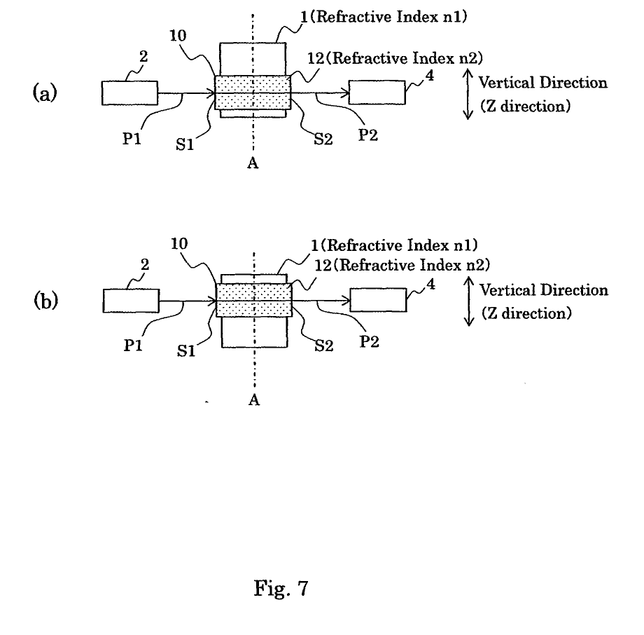

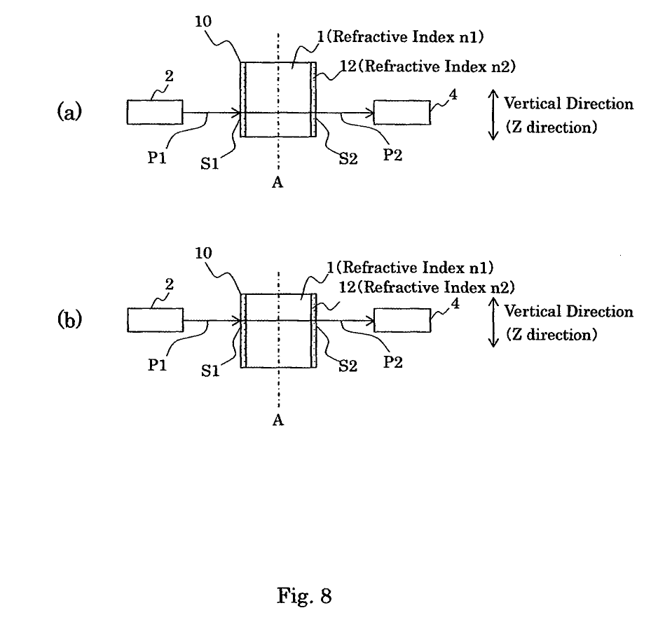

The container 10 stores at least a part of the DUT 1 to be measured by the terahertz wave measurement device. It should be noted that the container 10 may store the DUT 1 partially (refer to FIGS. 7(a) and 7(b)) or entirely (refer to FIGS. 8(a) and 8(b)).

The container 10 includes a gap portion 11 and an enclosure portion 12. The gap portion 11 is a circular gap with a radius of r viewed from above (refer to FIG. 1). At least a part of the DUT 1 is disposed inside the gap portion 11 (refer to FIG. 2).

The enclosure portion 12 includes a first flat surface portion S1 and a second flat surface portion S2. It should be noted that the first flat surface portion S1 and the second flat surface portion S2 are represented by straight lines in FIGS. 1 and 2. This is because FIGS. 1 and 2 are plan views. Actually, the container 10 has a thickness (refer to FIGS. 7(a), 7(b), 8(a), and 8(b)), and the first flat surface portion S1 and the second flat surface portion S2 are thus not straight lines, but flat surfaces. It should be noted that the first flat surface portion S1 and the second flat surface portion S2 are parallel with each other.

The gap portion 11 is arranged between the first flat surface portion S1 and the second flat surface portion S2. The enclosure portion 12 encloses the gap portion 11. On this occasion, a refractive index of the DUT 1 is denoted by n1, and a refractive index of the enclosure portion 12 is denoted by n2. Then, there holds a relationship n1−0.1≦n2≦n1+0.1. It is preferable that a relationship n1=n2 holds. Further, n1 and n2 may not be equal to the refractive index (such as 1) of ambient air of the container 10.

It should be noted that the material of the enclosure portion 12 may be a resin material such as Teflon (registered trademark), polyethylene, and the like. These resin materials cannot usually be used for measurement of a light ray in the visible light area or the infrared light area. However, these resin materials present a little absorption and scattering of the light ray of the terahertz wave, and can thus be used for measurement by means of the terahertz wave.

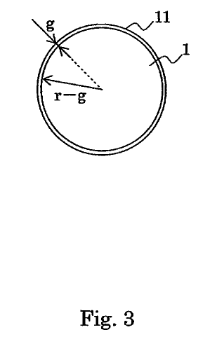

FIG. 3 is an enlarged plan view of the DUT 1 and the gap portion 11 when at least a part of the DUT 1 is stored in the container 10. The distance between a contour of a plane shape (shape viewed from above) of the DUT 1 and a contour of a plane shape (shape viewed from above) of the gap portion 11 is denoted by g. Then, the shape of the DUT 1 viewed from above is a circle with a radius of r-g. Thus, the DUT 1 is a cylinder having a bottom surface of a circle with the radius of r-g.

It is preferable that a relationship g≦λ/4 holds. It should be noted that λ denotes the wavelength of the terahertz wave output from the terahertz wave output device 2 of the terahertz wave measurement device toward the DUT 1. When the relationship g≦λ/4 holds, it is possible to restrain an air layer in the gap between the contour of the DUT 1 and the contour of the plane shape of the gap portion 11 from reflecting the terahertz wave. The reflection of the terahertz wave leads to a loss of the terahertz wave, and providing the relationship g≦λ/4 leads to the restraint of the loss of the terahertz wave.

It should be noted that, referring to FIG. 2, the first flat surface portion S1 intersects, at the right angle, with a travel direction of the terahertz wave output from the terahertz wave output device 2 of the terahertz wave measurement device toward the DUT 1. The container 10 is arranged as described above so as to measure the DUT 1 by the terahertz wave measurement device.

A description will now be given of an operation of the first embodiment.

Referring to FIG. 2, the terahertz wave output device 2 of the terahertz wave measurement device outputs the terahertz wave. The terahertz wave output from the terahertz wave output device 2 is orthogonally irradiated on the first flat surface portion S1. As a result, the terahertz wave is not refracted, but travels straight, and proceeds inside the enclosure portion 12.

On this occasion, the thickness of the air layer between the contour of the DUT 1 and the contour of the plane shape of the gap portion 11 is negligible. Further, there holds the relationship, (refractive index n1 of the DUT 1)=(refractive index n2 of the enclosure portion 12).

The terahertz wave, which has traveled inside the enclosure portion 12, is not refracted, but travels straight inside the DUT 1. Further, the terahertz wave transmits through the DUT 1, and is made incident to the enclosure portion 12. Then, the terahertz wave travels straight inside the enclosure portion 12, and transmits through the second flat surface portion S2. Finally, the terahertz wave output from the terahertz wave output device 2 transmits through the enclosure portion 12 and the DUT 1 while continuing to travel straight, and is made incident to the terahertz wave detector 4.

The terahertz wave detector 4 detects the incident terahertz wave. As a result, the DUT 1 is measured. For example, the DUT 1 includes contents 1a and 1b. Referring to FIG. 2, the terahertz wave transmits through the content 1b, and thus, the position and the like of the content 1b are revealed according to a result of the detection of the terahertz wave.

Though the operation of the first embodiment is described while assuming that the relationship (refractive index n1 of DUT 1)=(refractive index n2 of enclosure portion 12) holds, it can be roughly considered that the terahertz wave output from the terahertz wave output device 2 transmits through the enclosure portion 12 and the DUT 1 while continuing to travel straight as long as the relationship n1−0.1≦n2≦n1+0.1 holds.

According to the first embodiment, it is possible to restrain the terahertz wave from being refracted by the DUT 1 when the DUT 1 is measured by supplying the DUT 1 with the terahertz wave.

### Second Embodiment

A second embodiment is a method for scanning the DUT 1 in the horizontal direction (X direction) using the container 10 according to the first embodiment.

The configurations of the container 10 and the terahertz wave measurement device according to the second embodiment are the same as those according to the first embodiment, and hence a description is omitted.

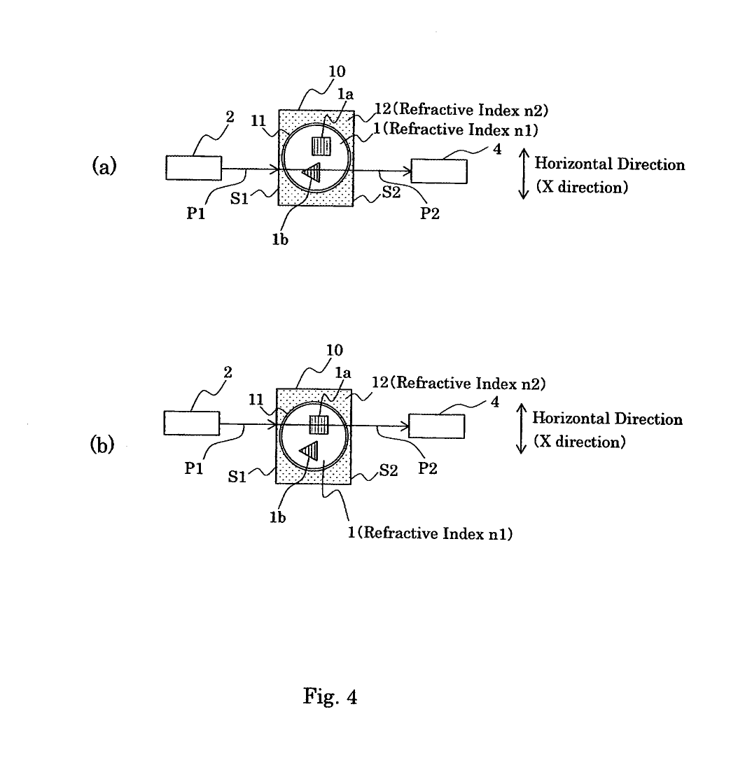

A description will now be given of an operation of the second embodiment. FIGS. 4(a) and 4(b) are plan views of the container 10 and the terahertz wave measurement device for describing the operation of the second embodiment.

Referring to FIG. 4(a), the terahertz wave output device 2 of the terahertz wave measurement device outputs the terahertz wave (referred to as “output step” hereinafter). The output terahertz wave transmits through the enclosure portion 12 and the DUT 1 while traveling straight as described in the first embodiment, and is detected by the terahertz wave detector 4 of the terahertz wave measurement device (referred to as “detection step” hereinafter). As a result, the DUT 1 is measured by the terahertz wave measurement device. Referring to FIG. 4(a), the terahertz wave transmits through the content 1b, and thus, the position and the like of the content 1b are revealed according to a result of the detection of the terahertz wave.

It should be noted that optical paths of the terahertz wave are denoted by P1 and P2. The optical path P1 is a path of the terahertz wave extending from the output Of the terahertz wave from the terahertz wave output device 2 to the incident to the container 10. The optical path P2 is a path of the terahertz wave extending from the transmission of the terahertz wave through the enclosure portion 12 and the DUT 1 to the arrival to the terahertz wave detector 4.

While the output step and the detection step are carried out, the container 10 and the DUT 1 move horizontally (downward in FIGS. 4(a) and 4(b)) with respect to the optical paths P1 and P2 of the terahertz wave. Then, the optical path P2 intersects with the content 1a as shown in FIG. 4(b). The terahertz wave transmits through the content 1a, and thus, the position and the like of the content 1a are revealed according to a result of the detection of the terahertz wave.

According to the second embodiment, the DUT 1 can be scanned in the horizontal direction (X direction). As a result, the DUT 1 can be tomographically measured.

A similar effect can be provided if the optical paths P1 and P2 of the terahertz wave move horizontally with respect to the container 10 and the DUT 1 (upward in FIGS. 4(a) and 4(b)) while the output step and the detection step are carried out. In order to move the optical paths P1 and P2 of the terahertz wave, the terahertz wave output device 2 and the terahertz wave detector 4 may be moved.

### Third Embodiment

A third embodiment is a method for scanning the DUT 1 using the container 10 according to the first embodiment while the DUT 1 is rotated.

The configurations of the container 10 and the terahertz wave measurement device according to the third embodiment are the same as those according to the first embodiment, and hence a description is omitted.

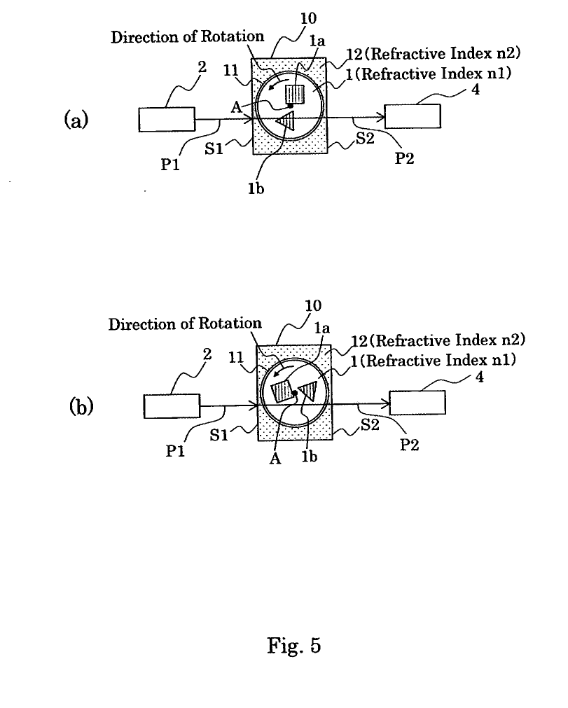

A description will now be given of an operation of the third embodiment. FIGS. 5(a) and 5(b) are plan views of the container 10 and the terahertz wave measurement device for describing the operation of the third embodiment. It should be noted that the definitions of the output step, the detection step, and the optical paths P1 and P2 are the same as those of the second embodiment.

Referring to FIG. 5(a), the output step is carried out. The output terahertz wave transmits through the enclosure portion 12 and the DUT 1 while traveling straight as described in the first embodiment. Then, the detection step is carried out. As a result, a certain part of the DUT 1 is measured by the terahertz wave measurement device.

While the output step and the detection step are carried out, the DUT 1 rotates about a line A extending vertically (Z direction) (refer to FIGS. 7(a), 7(b), 8(a), and 8(b)) as an axis of rotation (line A may not be a real member). For example, the DUT 1 rotates counterclockwise. Then, the DUT 1 is arranged as shown in FIG. 5(b). The part of the DUT 1 which intersects with the optical path P2 is different between the case in FIG. 5(b) and the case in FIG. 5(a). Thus, the case in FIG. 5(b) and the case in FIG. 5(a) can respectively measure the different parts of the DUT 1.

According to the third embodiment, the DUT 1 can be scanned while the DUT 1 is rotated. As a result, the DUT 1 can be tomographically measured.

### Fourth Embodiment

A fourth embodiment is a method for scanning the DUT 1 while the container 10 and the optical paths P1 and P2 of the terahertz wave are rotated using the container 10 according to the first embodiment.

The configurations of the container 10 and the terahertz wave measurement device according to the fourth embodiment are the same as those according to the first embodiment, and hence a description is omitted.

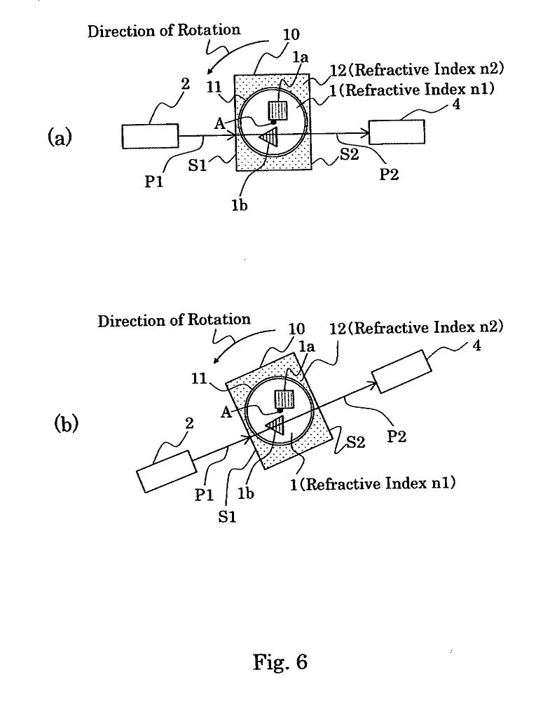

A description will now be given of an operation of the fourth embodiment. FIGS. 6(a) and 6(b) are plan views of the container 10 and the terahertz wave measurement device for describing the operation of the fourth embodiment. It should be noted that the definitions of the output step, the detection step, and the optical paths P1 and P2 are the same as those of the second embodiment.

Referring to FIG. 6(a), the output step is carried out. The output terahertz wave transmits through the enclosure portion 12 and the DUT 1 while traveling straight as described in the first embodiment. Then, the detection step is carried out. As a result, a certain part of the DUT 1 is measured by the terahertz wave measurement device.

While the output step and the detection step are carried out, the container 10 and the optical paths P1 and P2 of the terahertz wave rotate about the line A extending vertically (Z direction) (refer to FIGS. 7(a), 7(b), 8(a), and 8(b)) as an axis of rotation. For example, they may rotate counterclockwise. Then, the DUT 1 is arranged as shown in FIG. 6(b). The part of the DUT 1 which intersects with the optical path P2 is different between the case in FIG. 6(b) and the case in FIG. 6(a). Thus, the case in FIG. 6(b) and the case in FIG. 6(a) can respectively measure the different parts of the DUT 1.

According to the fourth embodiment, the DUT 1 can be scanned while the container 10 and the optical paths P1 and P2 of the terahertz wave are rotated. As a result, the DUT 1 can be tomographically measured.

### Fifth Embodiment

A fifth embodiment is a method for scanning the DUT 1 in the vertical direction (Z direction) using the container 10 according to the first embodiment.

FIGS. 7(a) and 7(b) are front views of the container 10 and the terahertz wave measurement device according to the fifth embodiment. The configurations of the container 10 and the terahertz wave measurement device according to the fifth embodiment are approximately the same as those according to the first embodiment. However, the DUT 1 is cylindrical, and a part of the DUT 1 is stored in the gap portion 11 of the container 10.

A description will now be given of an operation of the fifth embodiment. It should be noted that the definitions of the output step, the detection step, and the optical paths P1 and P2 are the same as those of the second embodiment.

Referring to FIG. 7(a), the output step is carried out. The output terahertz wave transmits through the enclosure portion 12 and the DUT 1 while traveling straight as described in the first embodiment. Then, the detection step is carried out. As a result, the lower part of the DUT 1 is measured by the terahertz wave measurement device.

While the output step and the detection step are carried out, the container 10 and the optical paths P1 and P2 of the terahertz wave move vertically (upward in FIGS. 7(a) and 7(b)) with respect to the DUT 1. Then, the optical path P2 intersects with an upper part of the DUT 1 as shown in FIG. 7(b). As a result, the upper part of the DUT 1 is measured by the terahertz wave measurement device. It is only necessary, for moving the optical paths P1 and P2 of the terahertz wave, to move the terahertz wave output device 2 and the terahertz wave detector 4.

According to the fifth embodiment, the DUT 1 can be scanned in the vertical direction (Z direction). As a result, the DUT 1 can be tomographically measured.

While the output step and the detection step are carried out, the DUT 1 may move vertically with respect to the container 10 and the optical paths P1 and P2 of the terahertz wave.

### Sixth Embodiment

A sixth embodiment is a method for scanning the DUT 1 in the vertical direction (Z direction) using the container 10 according to the first embodiment.

FIGS. 8(a) and 8(b) are front views of the container 10 and the terahertz wave measurement device according to the sixth embodiment. The configurations of the container 10 and the terahertz wave measurement device according to the sixth embodiment are approximately the same as those according to the first embodiment. However, the DUT 1 is cylindrical, and the entirety of the DUT 1 is stored in the gap portion 11 of the container 10.

A description will now be given of an operation of the sixth embodiment. It should be noted that the definitions of the output step, the detection step, and the optical paths P1 and P2 are the same as those of the second embodiment.

Referring to FIG. 8(a), the output step is carried out. The output terahertz wave transmits through the enclosure portion 12 and the DUT 1 while traveling straight as described in the first embodiment. Then, the detection step is carried out. As a result, the lower part of the DUT 1 is measured by the terahertz wave measurement device.

While the output step and the detection step are carried out, the container 10 and the DUT 1 move vertically (downward in FIGS. 8(a) and 8(b)) with respect to the optical paths P1 and P2 of the terahertz wave. Then, the optical path P2 intersects with an upper part of the DUT 1 as shown in FIG. 8(b). As a result, the upper part of the DUT 1 is measured by the terahertz wave measurement device.

According to the sixth embodiment, the DUT 1 can be scanned in the vertical direction (Z direction). As a result, the DUT 1 can be tomographically measured.

While the output step and the detection step are carried out, the optical paths P1 and P2 of the terahertz wave may move vertically with respect to the container 10 and the DUT 1.

### Seventh Embodiment

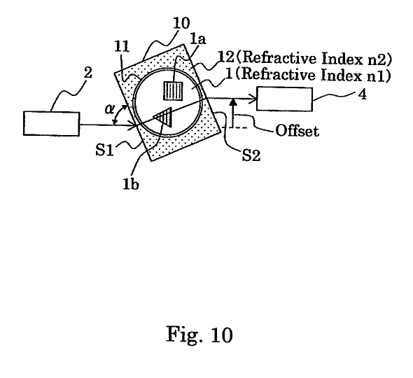

The container 10 according to the seventh embodiment is different from the container 10 according to the first embodiment in that the container 10 according to the seventh embodiment includes an insertion member 20. It should be noted that the container 10 according to the seventh embodiment can be used to scan the DUT 1 described in the second to sixth embodiments. Moreover, as an arrangement of the container 10 according to the seventh embodiment, a method described in an eighth embodiment (refer to FIG. 10) may be employed.

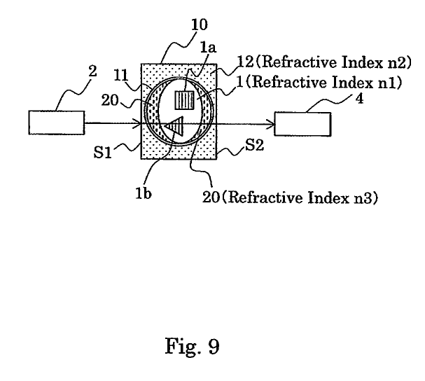

FIG. 9 is a plan view of a state in which at least a part of the DUT 1 is stored in the container 10 according to the seventh embodiment, and the terahertz wave is irradiated on the container 10.

The terahertz wave measurement device is the same as that of the first embodiment, and hence a description thereof is omitted.

The shape of the DUT 1 viewed from above is a shape obtained by removing a part of the circle with the radius r-g (refer to FIG. 3). In FIG. 9, the shape of the DUT 1 viewed from above is an ellipsoid with a major axis of r-g. Thus, the DUT 1 is an elliptic cylinder having a bottom surface of the ellipsoid with the major axis of r-g.

The insertion member 20 is inserted in a space between the DUT 1 and the gap portion 11. A contour of a plane shape (shape viewed from above) of an integrated body of the DUT 1 and the insertion member 20 is the circle with the radius of r-g. Thus, the DUT 1 and the insertion member 20 constitute the cylinder having the bottom of the circle with the radius of r-g. The contour (circle with the radius of r-g) of the plane shape of the integrated body of the DUT 1 and the insertion member 20 forms concentric circles along with the contour (circle of the radius of r) of the plane shape of the gap portion 11. It should be noted that the relationship g≦λ/4 preferably holds as in the first embodiment.

It should be noted that g denotes a distance between the contour (circle with the radius of r-g) of the plane shape of the integrated body of the DUT 1 and the insertion member 20 and the contour (circle with the radius of r) of the plane shape of the gap portion 11. λ denotes the wavelength of the terahertz wave output from the terahertz wave output device 2 of the terahertz wave measurement device toward the DUT 1.

On this occasion, the refractive index of the DUT 1 is denoted by n1, and a refractive index of the insertion member 20 is denoted by n3. Then, there holds a relationship n1−0.1≦n3≦n1+0.1. It is preferable that a relationship n1=n3 holds. Moreover, n1 and n3 may not be equal to the refractive index (such as 1) of the ambient air of the container 10.

An operation of the seventh embodiment is approximately the same as that of the first embodiment. However, the seventh embodiment is different from the first embodiment in a point that the terahertz wave transmits also through the insertion member 20. If the thickness g of the air layer is neglected, and a relationship n1=n2=n3 holds, the terahertz wave output from the terahertz wave output device 2 transmits through the enclosure portion 12, the insertion member 20, and the DUT 1 while continuing to travel straight.

According to the seventh embodiment, there are obtained the same effects as in the first embodiment.

Moreover, according to the seventh embodiment, even if the DUT 1 is not a cylinder, since the insertion member 20 serves to integrate the DUT 1 and the insertion member 20 into a cylinder, the DUT 1 can be treated as a cylinder. For example, the third embodiment (refer to FIGS. 5(a) and 5(b)) and the fourth embodiment (refer to FIGS. 6(a) and 6(b)) can be applied if the DUT 1 is not cylindrical.

The description has been given of the seventh embodiment assuming that the DUT 1 is an elliptic cylinder. However, the DUT 1 may not be a solid of revolution such as an elliptic cylinder. It is only necessary for the integrated body of the DUT 1 and the insertion member 20 to form a cylinder.

Moreover, the container 10 may include, in place of the insertion member 20, a filling material (a liquid such as oil, for example) filled in the space between the DUT 1 and the gap portion 11. When a refractive index of the filling material is denoted by n4 and the refractive index of the DUT 1 is denoted by n1, there holds a relationship n1−0.1≦n4≦n1+0.1. It is preferable that a relationship n1=n4 holds. Moreover, n1 and n4 may not be equal to the refractive index (such as 1) of the ambient air of the container 10.

### Eighth Embodiment

The eighth embodiment is different from the first embodiment in the arrangement of the container 10 according to the first embodiment with respect to the terahertz wave measurement device.

FIG. 10 is a plan view of a state in which at least a part of the DUT 1 is stored in the container 10 according to the eighth embodiment, and the terahertz wave is irradiated on the container 10.

The configurations of the container 10 and the terahertz wave measurement device are the same as those of the first embodiment, and hence a description is omitted.

It should be noted that, referring to FIG. 10, the first flat surface portion S1 intersects with the travel direction of the terahertz wave output from the terahertz wave output device 2 of the terahertz wave measurement device toward the DUT 1 at an angle α, which is more than 0 degree and less than 90 degrees. The container 10 is arranged as described above so as to measure the DUT 1 by the terahertz wave measurement device.

A description will now be given of an operation of the eighth embodiment.

Referring to FIG. 10, the terahertz wave output device 2 of the terahertz wave measurement device outputs the terahertz wave. The terahertz wave output from the terahertz wave output device 2 is irradiated on the first flat surface portion S1. On this occasion, the terahertz wave is refracted, and then travels straight inside the enclosure portion 12.

On this occasion, the thickness of the air layer between the contour of the DUT 1 and the contour of the plane shape of the gap portion 11 is negligible. Further, there holds the relationship, (refractive index n1 of the DUT 1)=(refractive index n2 of the enclosure portion 12).

The terahertz wave, which has traveled inside the enclosure portion 12, is not refracted, but travels straight inside the DUT 1. Further, the terahertz wave transmits through the DUT 1, and is made incident to the enclosure portion 12. Then, the terahertz wave travels straight inside the enclosure portion 12, and transmits through the second flat surface portion S2. On this occasion, the terahertz wave is refracted, travels in a direction parallel with the travel direction of the terahertz wave output from the terahertz wave output device 2, and is made incident to the terahertz wave detector 4.

Eventually, the optical path of the terahertz wave output from the terahertz wave output device 2 is displaced by a predetermined distance (offset), and the terahertz wave is made incident to the terahertz wave detector 4.

The terahertz wave detector 4 detects the incident terahertz wave. As a result, the DUT 1 is measured. For example, the DUT 1 includes the contents 1a and 1b. Referring to FIG. 10, the terahertz wave transmits through the content 1b, and thus, the position and the like of the content 1b are revealed according to a result of the detection of the terahertz wave.

Though the operation of the eighth embodiment is described while assuming that the relationship (refractive index n1 of DUT 1)=(refractive index n2 of enclosure portion 12) holds, an approximately similar operation is provided as long as the relationship n1−0.1≦n2≦n1+0.1 holds.

According to the eighth embodiment, it is possible to restrain the terahertz wave from being refracted by the DUT 1 when the DUT 1 is measured by supplying the DUT 1 with the terahertz wave.

Moreover, according to the eighth embodiment, the optical path of the terahertz wave output from the terahertz wave output device 2 is displaced by the predetermined distance (offset), and the terahertz wave is made incident to the terahertz wave detector 4. As a result, the eighth embodiment is suitable for a case in which the terahertz wave detector 4 is not present in the traveling direction of the terahertz wave output from the terahertz wave output device 2.

### Ninth Embodiment

A ninth embodiment is different from the first embodiment in that enclosure portions 12a and 12b can be separated along separation surfaces D1 and D2. It should be noted that the container 10 according to the ninth embodiment can be used to scan the DUT 1 described in the second to sixth embodiments. Moreover, as an arrangement of the container 10 according to the ninth embodiment, the method described in the eighth embodiment (refer to FIG. 10) may be employed.

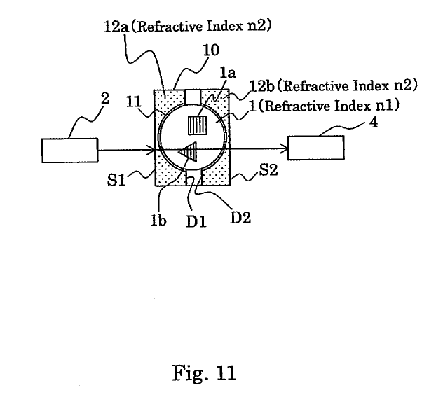

FIG. 11 is a plan view of a state in which at least a part of the DUT 1 is stored in the container 10 according to the ninth embodiment, and the terahertz wave is irradiated on the container 10.

The configurations of the container 10 and the terahertz wave measurement device are approximately the same as those of the first embodiment. It should be noted that the container 10 includes the enclosure portions 12a and 12b in place of the enclosure portion 12. The enclosure portions 12a and 12b can be separated along the separation surfaces D1 and D2. Moreover, the separation surfaces D1 and D2 intersect with the gap portion 11. It should be noted that the separation surfaces D1 and D2 may be separated from each other as shown in FIG. 11. Moreover, the enclosure portions 12a and 12b are coupled to each other by coupling means, which is not shown. In the case shown in FIG. 11, the contour of a plane shape of the gap portion 11 includes an arc protruding leftward and an arc protruding rightward.

An operation of the ninth embodiment is the same as the operation of the first embodiment, and hence a description thereof is omitted.

With the container 10 according to the ninth embodiment, since the enclosure portions 12a and 12b can be separated along the separation surfaces D1 and D2, the DUT 1 can be easily stored in the gap portion 11. For example, the enclosure portions 12a and 12b are separated along the separation surfaces D1 and D2, and the DUT 1 is then stored inside the gap portion 11. Then, the enclosure portions 12a and 12b is coupled to each other by the coupling means, which is not shown.

### Tenth Embodiment

The container 10 according to a tenth embodiment is adapted to a case in which the DUT 1 is constructed by multiple cylinders. It should be noted that the container 10 according to the tenth embodiment can be used to scan the DUT 1 described in the second to sixth embodiments. Moreover, as an arrangement of the container 10 according to the tenth embodiment, the method described in the eighth embodiment (refer to FIG. 10) may be employed.

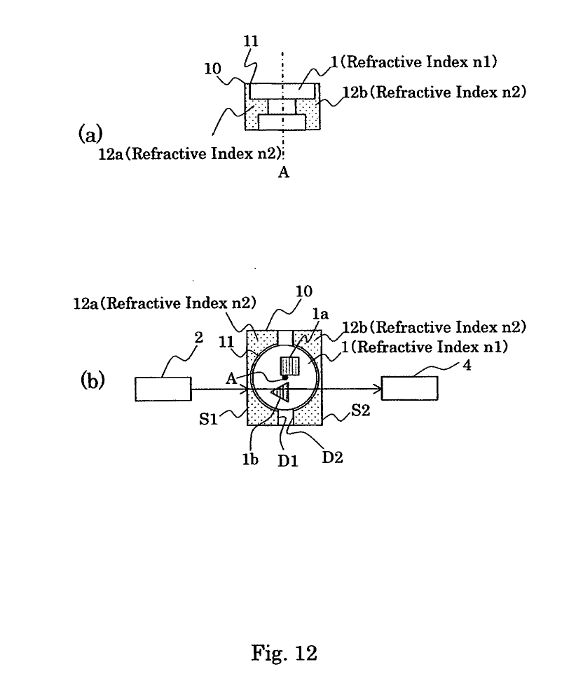

FIGS. 12(a) and 12(b) are views when the DUT 1 is stored in the container 10 according to the tenth embodiment, in which FIG. 12(a) is a cross sectional view, and FIG. 12(b) is a plan view. It should be noted that the gap between the container 10 and the gap portion 11 is omitted for the sake of illustration in FIG. 12(a).

Referring to FIG. 12(a), the DUT 1 is constructed by three cylinders, and the diameter of a bottom surface changes according to the height. There holds a relationship (diameter of bottom surface of top cylinder)>(diameter of bottom surface of bottom cylinder)>(diameter of bottom surface of center cylinder). It is only necessary for the DUT 1 to form a solid of revolution, and the DUT 1 may be a spheroid. It should be noted that the center axis of the solid of revolution needs to coincide with the line A.

On this occasion, a radius of a contour of a plane shape of the gap portion 11 changes according to the height of the gap portion 11. This corresponds to the case that the diameter of the bottom surface of the DUT 1 changes according to the height thereof.

Referring to FIG. 12(b), the enclosure portions 12a and 12b can be separated along the separation surfaces D1 and D2. Moreover, the separation surfaces D1 and D2 intersect with the gap portion 11 (which is similar to the ninth embodiment). As a result, the DUT 1 can be easily stored in the gap portion 11. For example, the enclosure portions 12a and 12b are separated along the separation surfaces D1 and D2, and the DUT 1 is then stored inside the gap portion 11. Then, the enclosure portions 12a and 12b is coupled to each other by the coupling means, which is not shown.

It should be noted that the positions of the terahertz wave output device 2 and the terahertz wave detector 4 of the terahertz wave measurement device and the positions of the optical paths P1 and P2 in FIG. 12(b) are similar to those in FIG. 11, and hence a description is omitted.

1. A container that contains at least a part of a device under test to be measured by an electromagnetic wave measurement device, comprising:
a gap portion that internally disposes at least a part of the device under test; and
an enclosure portion that comprises a first flat surface portion and a second flat surface portion, and disposes the gap portion between the first flat surface portion and the second flat surface portion, thereby enclosing the gap portion, wherein:
a relationship n1≦0.1≦n2≦n1+0.1 holds,
where n2 denotes a refractive index of the enclosure portion and n1 denotes a refractive index of the device under test; and
the electromagnetic wave measurement device outputs an electromagnetic wave having a frequency equal to or more than 0.01 [THz] and equal to or less than 100 [THz] toward the device under test.

2. The container according to claim 1, wherein a contour of a plane shape of the gap portion includes an arc.

3. The container according to claim 2, wherein a radius of the contour of the plane shape of the gap portion changes according to the height of the gap portion.

4. The container according to claim 1, wherein:
the enclosure portion can be divided along a separation surface; and
the separation surface intersects with the gap portion.

5. The container according to claim 1, comprising an insertion member that is inserted in a space between the device under test and the gap portion, wherein:
a contour of a plane shape of an integrated body of the device under test and the insertion member is concentric with a contour of a plane shape of the gap portion; and
a relationship n1≦0.1≦n3<n1+0.1 holds,
where n3 denotes a refractive index of the insertion member and n1 denotes the refractive index of the device under test.

6. The container according to claim 5, wherein a distance between the contour of the plane shape of the integrated body of the device under test and the insertion member and the contour of the plane shape of the gap portion is equal to or less than a quarter of the wavelength of the electromagnetic wave output from the electromagnetic wave measurement device toward the device under test.

7. The container according to claim 1, comprising a filling member that is filled in a space between the device under test and the gap portion, wherein a relationship n1−0.1≦n4≦n1+0.1 holds, where n4 denotes a refractive index of the filling member and n1 denotes the refractive index of the device under test.

8. The container according to claim 1, wherein a distance between a contour of a plane shape of the device under test and a contour of a plane shape of the gap portion is equal to or less than a quarter of the wavelength of the electromagnetic wave output from the electromagnetic wave measurement device toward the device under test.

9. A container arrangement method for arranging the container according to claim 1 containing the device under test for measuring the device under test by the electromagnetic wave measurement device, comprising arranging the container such that the first flat surface portion intersects, at the right angle, with a travel direction of the electromagnetic wave output from the electromagnetic wave measurement device toward the device under test.

10. A container arrangement method for arranging the container according to claim 1 containing the device under test for measuring the device under test by the electromagnetic wave measurement device, comprising arranging the container such that the first flat surface portion intersects with a travel direction of the electromagnetic wave output from the electromagnetic wave measurement device toward the device under test at an angle more than 0 degree and less than 90 degrees.

11. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the container and the device under test move horizontally with respect to an optical path of the electromagnetic wave while the electromagnetic wave is being outputted and detected.

12. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein an optical path of the electromagnetic wave moves horizontally with respect to the container while the electromagnetic wave is being outputted and detected.

13. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the device under test rotates about a line extending vertically as an axis of rotation while the electromagnetic wave is being outputted and detected.

14. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the container and an optical path of the electromagnetic wave rotate about a line extending vertically as an axis of rotation while the electromagnetic wave is being outputted and detected.

15. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the container and an optical path of the electromagnetic wave move vertically with respect to the device under test while the electromagnetic wave is being outputted and detected.

16. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the container and the device under test move vertically with respect to an optical path of the electromagnetic wave while the electromagnetic wave is being outputted and detected.

17. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein the device under test moves vertically with respect to the container and an optical path of the electromagnetic wave while the electromagnetic wave is being outputted and detected.

18. A measurement method of the device under test contained in the container according to claim 1 using the electromagnetic wave measurement device, comprising:
outputting the electromagnetic wave by the electromagnetic wave measurement device; and
detecting the electromagnetic wave which has transmitted through the device under test by the electromagnetic wave measurement device,
wherein an optical path of the electromagnetic wave moves vertically with respect to the container and the device under test while the electromagnetic wave is being outputted and detected.
